(19) United States
(12) Patent Application Publication
(10) Pub. No.: US 2018/0089574 A1
(43) Pub. Date: Mar. 29, 2018

(54) DATA PROCESSING DEVICE, DATA PROCESSING METHOD, AND COMPUTER-READABLE RECORDING MEDIUM

(71) Applicant: NEC CORPORATION, Tokyo (JP)

(72) Inventor: Yoshiyuki GOTO, Tokyo (JP)

(21) Appl. No.: 15/716,603

(22) Filed: Sep. 27, 2017

(30) Foreign Application Priority Data
Sep. 27, 2016 (JP) 2016-188910

(51) Int. Cl. G06N 5/04; G06N 99/00; H04L 9/00

(52) U.S. Cl. CPC G06N 5/04; H04L 9/008; G06N 99/005

(57) ABSTRACT

A data processing device 100 is intended to provide learning data to a system 200 that generates a prediction model by performing machine learning. The data processing device 100 includes: a data obtaining unit 10 that obtains learning data input from the outside; an encryption unit 20 that encrypts the learning data so that a prediction model generated from the learning data in an unencrypted state and a prediction model generated from the learning data in an encrypted state have a corresponding relationship with each other in terms of parameters, numeric values, and operators; and a data output unit 30 that outputs the encrypted learning data to the system 200.

### CROSS-REFERENCE TO RELATED APPLICATION

This application is based upon and claims the benefit of priority from Japanese patent application No. 2016-188910, filed on Sep. 27, 2016, the disclosure of which is incorporated herein in its entirety by reference.

### BACKGROUND OF THE INVENTION

### 1. Field of the Invention

The present invention relates to a data processing device and a data processing method for providing learning data to a system that performs machine learning, and further relates to a computer-readable recording medium having recorded therein a program for realizing these device and method.

### 2. Background Art

In recent years, efforts have been actively made to take advantage of stored data in business operations with the aid of machine learning. Machine learning is a technique to make judgments or predictions by finding patterns using a computer based on accumulated data. Machine learning is increasingly used in, for example, prediction of demand for a product, prediction of a selling price, logistics management, and so forth.

For example, Patent Document 1 discloses a method of predicting observation values with high precision by learning past observation values through machine learning. On the other hand, Non-Patent Document 1 discloses a distributed heterogeneous mixture learning technique to find mixed patterns by analyzing big data composed of tens of millions of data pieces.

Normally, in order to perform such machine learning, a high-performance computing system is required because it is necessary to conduct massive data analysis. In view of this, Non-Patent Document 1 takes advantage of a distributed computing environment. Meanwhile, in order to facilitate the use of a high-performance computing system, Non-Patent Documents 2 and 3 suggest a cloud service that provides a machine learning platform through a cloud computing environment.

When using a machine learning service provided by a cloud system, a user needs to transmit data to the cloud system that provides the service via the Internet. Therefore, a provider of a cloud service takes security measures, examples of which include checking system vulnerability and performing encryption on databases and communication channels.

Patent Document 2 suggests a system that applies encryption processing to data transmitted from a user to a cloud system as a security measure for the user. In the system disclosed in Patent Document 2, only encrypted data is transmitted from the user to the cloud system.

Patent Document 1: JP 2015-82259A

Patent Document 2: JP 2016-512612A

Non-Patent Document 1: “NEC Develops Distributed Heterogeneous Mixture Learning Technology on Spark that Rapidly Discovers Patterns Hidden in Super-Large-Scale Data.” Press Release on NEC Website. NEC Corporation, 26 May 2016. Web. 16 Aug. 2016. <http://jpn.nec.com/press/201605/20160526_01.html>.

Non-Patent Document 2: “Google Cloud Machine Learning.” Google Cloud Platform, n.d. Web. 16 Aug. 2016. <https://cloud.google.com/ml/>.

Non-Patent Document 3: “Microsoft Azure.” Microsoft, n.d. Web. 16 Aug. 2016. <https://azure.microsoft.com/ja-jp/services/machine-learning/>.

When the system disclosed in the above-listed Patent Document 2 is used, the provider's system needs to execute decryption processing every time it receives data. This increases a load on the system. If an amount of transmitted data increases, the load on the system increases accordingly, thereby adversely affecting the performance of business processing. Furthermore, depending on the mode of provision of a cloud service, there is a possibility that the decryption processing cannot be implemented on an analysis application of the cloud service.

### SUMMARY OF THE INVENTION

An exemplary object of the present invention is to solve the foregoing issues by providing a data processing device, a data processing method, and a program that enable a system to perform machine learning without executing decryption processing, even when data used in machine learning is encrypted.

In order to achieve the foregoing object, a data processing device according to one aspect of the present invention is intended to provide learning data to a system that generates a prediction model by performing machine learning. The data processing device includes: a data obtaining unit that obtains the learning data input from the outside; an encryption unit that encrypts the learning data so that a prediction model generated from the learning data in an unencrypted state and a prediction model generated from the learning data in an encrypted state have a corresponding relationship with each other in terms of parameters, numeric values, and operators; and a data output unit that outputs the encrypted learning data to the system.

In order to achieve the foregoing object, a data processing method according to another aspect of the present invention is intended to provide learning data to a system that generates a prediction model by performing machine learning. The data processing method includes: (a) a step of obtaining the learning data input from the outside; (b) a step of encrypting the learning data so that a prediction model generated from the learning data in an unencrypted state and a prediction model generated from the learning data in an encrypted state have a corresponding relationship with each other in terms of parameters, numeric values, and operators; and (c) a step of outputting the encrypted learning data to the system.

In order to achieve the foregoing object, a computer-readable recording medium according to still another aspect of the present invention records a program. The program is intended to, using a computer, provide learning data to a system that generates a prediction model by performing machine learning. The program includes an instruction that causes the computer to execute: (a) a step of obtaining the learning data input from the outside; (b) a step of encrypting the learning data so that a prediction model generated from the learning data in an unencrypted state and a prediction model generated from the learning data in an encrypted state have a corresponding relationship with each other in terms of parameters, numeric values, and operators; and (c) a step of outputting the encrypted learning data to the system.

As described above, the present invention enables a system to perform machine learning without executing decryption processing, even when data used in machine learning is encrypted.

### BRIEF DESCRIPTION OF THE DRAWINGS

FIG. 1 is a block diagram showing a schematic configuration of a data processing device according to an exemplary embodiment of the present invention.

FIG. 2 is a block diagram showing a specific configuration of the data processing device according to the exemplary embodiment of the present invention.

FIG. 3 is a flowchart of processing executed by the data processing device according to the exemplary embodiment of the present invention to encrypt learning data.

FIG. 4 shows an example of the learning data used in the exemplary embodiment of the present invention.

FIG. 5 shows an example of the learning data in which attribute names have been encrypted in the exemplary embodiment of the present invention.

FIG. 6 shows an example of the learning data in which a specific attribute has been standardized in the exemplary embodiment of the present invention.

FIG. 7 shows an example of the learning data in which a specific attribute has been binarized in the exemplary embodiment of the present invention.

FIG. 8 is a flowchart of processing executed by an analysis application according to the exemplary embodiment of the present invention to generate a prediction model.

FIG. 9 shows an example of the learning data that has been standardized by the analysis application in the exemplary embodiment of the present invention.

FIG. 10 shows an example of the learning data that has been binarized by the analysis application in the exemplary embodiment of the present invention.

FIG. 11 shows an example of the prediction model generated in the exemplary embodiment of the present invention.

FIG. 12 is a flowchart of processing executed by the data processing device according to the exemplary embodiment of the present invention to encrypt prediction data.

FIG. 13 shows an example of the prediction data used in the exemplary embodiment of the present invention.

FIG. 14 shows an example of the prediction data in which attribute names have been encrypted in the exemplary embodiment of the present invention.

FIG. 15 shows an example of the prediction data in which a specific attribute has been standardized in the exemplary embodiment of the present invention.

FIG. 16 shows an example of the prediction data in which a specific attribute has been binarized in the exemplary embodiment of the present invention.

FIG. 17 is a flowchart of prediction processing executed by a prediction application according to the exemplary embodiment of the present invention.

FIG. 18 shows an example of the prediction data that has been standardized by the prediction application in the exemplary embodiment of the present invention.

FIG. 19 shows an example of the prediction data that has been binarized by the prediction application in the exemplary embodiment of the present invention.

FIG. 20 shows an example of the prediction result obtained by the prediction application in the exemplary embodiment of the present invention.

FIG. 21 is a flowchart of processing executed by the data processing device according to the exemplary embodiment of the present invention to visualize the prediction model.

FIG. 22 shows an example of the prediction model in which an attribute targeted for binarization has been decrypted in the exemplary embodiment of the present invention.

FIG. 23 shows an example of the prediction model in which an attribute targeted for standardization has been decrypted in the exemplary embodiment of the present invention.

FIG. 24 shows an example of the prediction model in which attribute names have been decrypted in the exemplary embodiment of the present invention.

FIG. 25 is a block diagram showing an example of a computer that realizes the data processing device according to the exemplary embodiment of the present invention.

### EXEMPLARY EMBODIMENT

### Overview of the Invention

The present invention is useful for a cloud service that provides a machine learning platform through a cloud computing environment. For example, the present invention is useful in a case where learning processing executed by an analysis application of the cloud service has the following two steps: preprocessing and analysis processing. In this case, the present invention performs data encryption so that the result of preprocessing using unencrypted data is identical to the result of preprocessing using encrypted data.

In the present invention, the analysis application of the cloud service generates a prediction model by applying preprocessing and analysis processing to encrypted input data. This prediction model is identical to a prediction model generated using unencrypted data. Therefore, at a minimum encryption processing cost, learning processing of the present invention can achieve the same result as learning processing that uses unencrypted data. Furthermore, the present invention can guarantee a user security without any reliance on a provider of the cloud service.

### Exemplary Embodiment

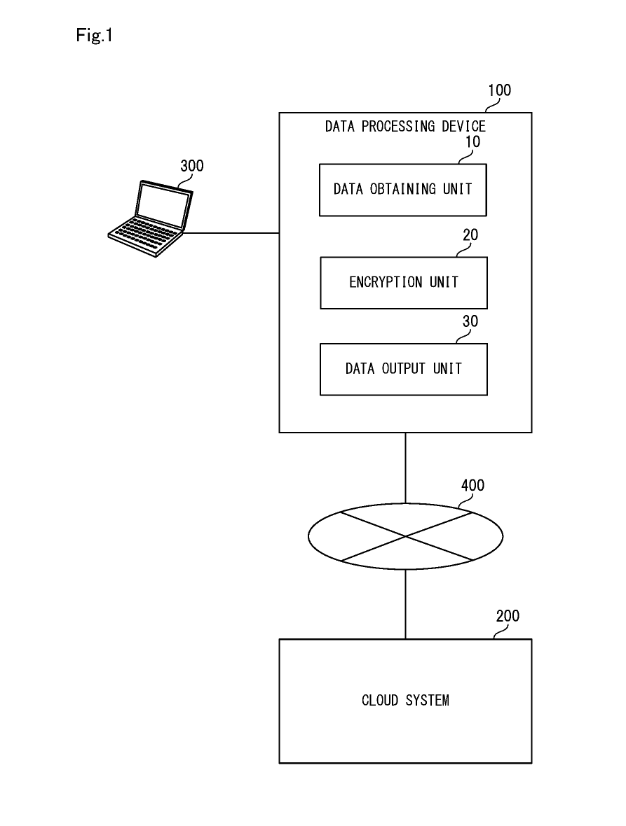

The following describes a data processing device, a data processing method, and a program according to an exemplary embodiment of the present invention with reference to FIGS. 1 to 25.

### Device Configuration

First, a configuration of the data processing device according to the present exemplary embodiment will be described with reference to FIG. 1. FIG. 1 is a block diagram showing a schematic configuration of the data processing device according to the exemplary embodiment of the present invention.

A data processing device 100 according to the present exemplary embodiment shown in FIG. 1 is intended to provide learning data to a cloud system 200 that generates a prediction model by performing machine learning. As shown in FIG. 1, in the present exemplary embodiment, a terminal device 300 used by a user is connected to the data processing device 100. The data processing device 100 is connected to the cloud system 200 via the Internet 400.

As shown in FIG. 1, the data processing device 100 includes a data obtaining unit 10, an encryption unit 20, and a data output unit 30. Among these, the data obtaining unit 10 obtains the learning data input from the external terminal device 300.

The encryption unit 20 encrypts the learning data so that a prediction model generated from the learning data in an unencrypted state and a prediction model generated from the learning data in an encrypted state have a corresponding relationship with each other in terms of parameters, numeric values, and operators. The data output unit 30 outputs the encrypted learning data to the cloud system 200.

Therefore, even when the learning data is encrypted, the cloud system 200 according to the present exemplary embodiment generates a prediction model that is similar to a prediction model generated when the learning data is not encrypted. Thus, the cloud system 200 according to the present exemplary embodiment can perform machine learning without executing decryption processing, even when data used in machine learning is encrypted. This suppresses an increase in a load on the cloud system, even when an amount of learning data has increased.

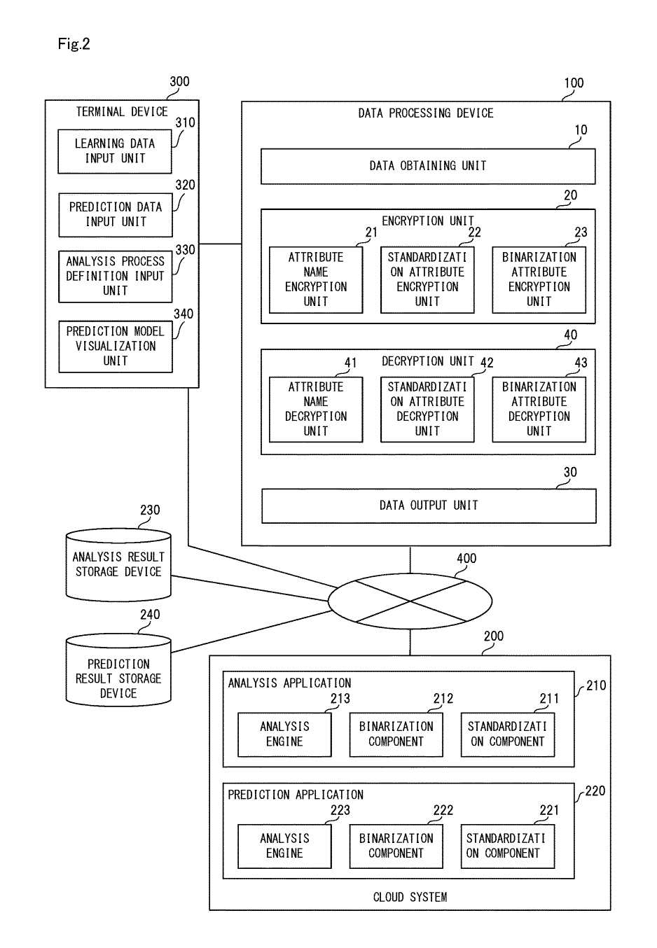

Below, the configuration of the data processing device according to the present exemplary embodiment will be described in a more specific manner using FIG. 2. FIG. 2 is a block diagram showing a specific configuration of the data processing device according to the exemplary embodiment of the present invention.

As shown in FIG. 2, in the present exemplary embodiment, the cloud system 200 includes an analysis application 210 and a prediction application 220. The analysis application 210 and the prediction application 220 are both web applications installed on the cloud system 200.

The analysis application 210 receives encrypted learning data from the data processing device 100 via the Internet 400, and generates a prediction model based on the received learning data. The analysis application 210 also transfers the generated prediction model to an analysis result storage device 230 via the Internet 400. As will be described later, the prediction model is decrypted so as to enable the user to visually check the prediction model.

Specifically, the analysis application 210 includes a standardization component 211, a binarization component 212, and an analysis engine 213. Among these, the standardization component 211 standardizes data values of the learning data that belong to a specific attribute in accordance with a specific rule. The binarization component 212 binarizes data values of the learning data that belong to an attribute for which standardization is not performed. The analysis engine 213 generates the prediction model using the learning data that has been standardized and binarized.

Upon receiving encrypted prediction data from the data processing device 100 via the Internet 400, the prediction application 220 obtains the prediction model from the analysis result storage device 230, and executes prediction processing using the obtained prediction model. The prediction application 220 also transfers the prediction result to a prediction result storage device 240 via the Internet 400.

Specifically, the prediction application 220 includes a standardization component 221, a binarization component 222, and an analysis engine 223. Among these, the standardization component 221 standardizes data values of the prediction data that belong to a specific attribute in accordance with a specific rule. The binarization component 222 binarizes data values of the prediction data that belong to an attribute for which standardization is not performed. The analysis engine 223 predicts data by applying the prediction data that has been standardized and binarized to the prediction model.

The analysis result storage device 230 is a general database installed on the Internet 400. The analysis result storage device 230 receives an analysis process definition and the prediction model from the analysis application 210 of the cloud system 200 via the Internet 400, and stores them.

The analysis result storage device 230 also outputs the analysis process definition and the prediction model in response to a request from the prediction application 220. The analysis result storage device 230 is connected to the data processing device 100 via a local network, and transfers the prediction model to a decryption unit 40 of the data processing device 100.

Similarly to the analysis result storage device 230, the prediction result storage device 240 is a general database installed on the Internet 400. The prediction result storage device 240 receives the prediction result from the prediction application 220 of the cloud system 200 via the

Internet 400, and stores the same.

In the present exemplary embodiment, the terminal device 300 used by the user includes a learning data input unit 310, a prediction data input unit 320, an analysis process definition input unit 330, and a prediction model visualization unit 340.

Among these, the learning data input unit 310 inputs a file of the learning data to the data processing device 100. The prediction data input unit 320 inputs a file of the prediction data to the data processing device 100. The analysis process definition input unit 330 inputs a file of the analysis process definition to the data processing device 100. The prediction model visualization unit 340 generates image data for visualizing the prediction model, and inputs the same to a display device of the terminal device 300.

The analysis process definition defines specific contents of later-described standardization processing and binarization processing. In practice, the terminal device 300 is constructed by installing a program that realizes various function units in a computer that holds the file of the learning data, the file of the prediction data, and the file of the analysis process definition. The terminal device 300 transfers these files to the data processing device 100 via the local network.

As shown in FIG. 2, in the present exemplary embodiment, the encryption unit 20 of the data processing device 100 includes an attribute name encryption unit 21, a standardization attribute encryption unit 22, and a binarization attribute encryption unit 23.

The attribute name encryption unit 21 encrypts attribute names in the learning data. The standardization attribute encryption unit 22 encrypts data values of the learning data that belong to a specific attribute through standardization processing that uses a specific calculation formula. The binarization attribute encryption unit 23 encrypts data values of the learning data that belong to an attribute other than the specific attribute (that belong to an attribute for which standardization is not performed) through binarization processing that uses a threshold.

That is to say, in the present exemplary embodiment, encryption is performed through encryption of attribute names, standardization, and binarization so that a prediction model generated from the learning data in an unencrypted state and a prediction model generated from the learning data in an encrypted state have a corresponding relationship with each other in terms of parameters, numeric values, and operators.

Thereafter, the data output unit 30 transmits the learning data that has been encrypted by the attribute name encryption unit 21, the standardization attribute encryption unit 22, and the binarization attribute encryption unit 23 to the cloud system 200. The analysis application 210 of the cloud system 200 accordingly generates the prediction model in the above-described manner.

In the present exemplary embodiment, the data obtaining unit 10 can also obtain the prediction data and the analysis process definition, which are used in prediction based on the prediction model, in addition to the learning data from the terminal device 300. When the data obtaining unit 10 has obtained the prediction data, the encryption unit 20 encrypts the prediction data similarly to the learning data.

In this case, the data output unit 30 transmits the encrypted prediction data to the cloud system 200. The prediction application 220 of the cloud system 200 accordingly applies prediction processing to the prediction data in the above-described manner.

As shown in FIG. 2, in the present exemplary embodiment, the data processing device 100 includes the decryption unit 40 that decrypts the prediction model in addition to the data obtaining unit 10, the encryption unit 20, and the data output unit 30. The decryption unit 40 includes an attribute name decryption unit 41, a standardization attribute decryption unit 42, and a binarization attribute decryption unit 43.

The attribute name decryption unit 41 specifies, from the prediction model, a portion related to encrypted attribute names, and decrypts the specified portion. The standardization attribute decryption unit 42 specifies, from the prediction model, a portion related to values that have undergone standardization processing, and decrypts the specified portion. The binarization attribute decryption unit specifies, from the prediction model, a portion related to values that have undergone binarization processing, and decrypts the specified portion.

As stated earlier, the analysis application 210 generates the prediction model from the encrypted learning data, and stores the prediction model to the analysis result storage device 230. Therefore, the decryption unit 40 obtains the prediction model from the analysis result storage device 230 via the local network.

As will be described later, in the present exemplary embodiment, the data processing device 100 is constructed by installing a program in a computer. Furthermore, the data processing device 100 may be constructed using a plurality of computers, rather than using a single computer. For example, the encryption unit 20 and the decryption unit 40 may be constructed using separate computers.

### Device Operations

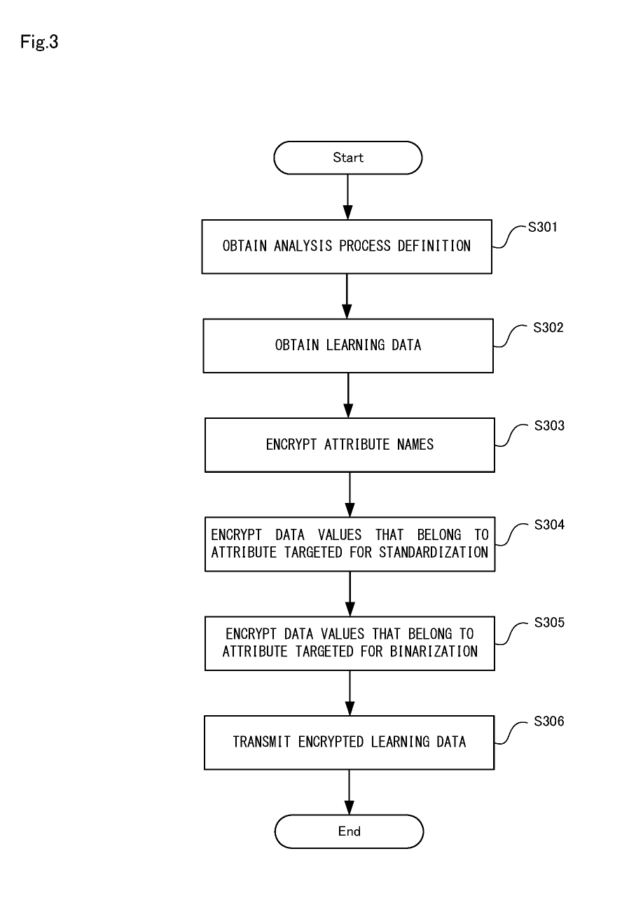

Below, the operations of the data processing device 100 according to the present exemplary embodiment will be described using FIGS. 3 to 24. In the following description, FIG. 1 will be referred to as appropriate. In the present exemplary embodiment, the data processing method is implemented by causing the data processing device 100 to operate. Therefore, the following description of the operations of the data processing device 100 applies to the data processing method according to the present exemplary embodiment.

### Processing for Encrypting Learning Data

First, processing for encrypting learning data will be described using FIGS. 3 to 7. FIG. 3 is a flowchart of processing executed by the data processing device according to the exemplary embodiment of the present invention to encrypt learning data.

This processing is based on the premise that the user inputs an analysis process definition on the terminal device 30, and the analysis process definition input unit 330 inputs the input analysis process definition to the data processing device 100. At this time, the analysis process definition input unit 330 also transmits the analysis process definition to the cloud system 200 via the Internet 400.

As shown in FIG. 3, first, the data obtaining unit 10 of the data processing device 100 obtains the transmitted analysis process definition (step S301). The data obtaining unit 10 transfers the obtained analysis process definition to the encryption unit 20 and the decryption unit 40.

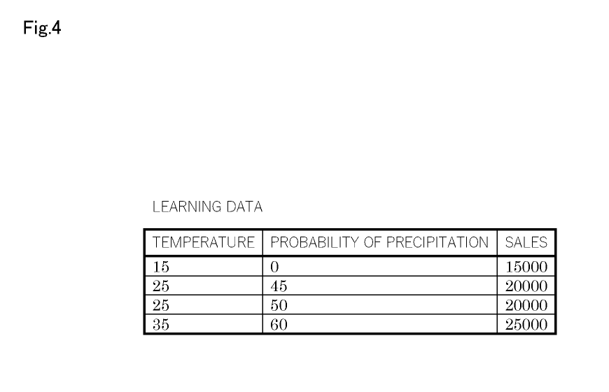

Next, once the learning data input unit 310 of the terminal device 300 has transmitted learning data shown in FIG. 4 to the data processing device 100, the data obtaining unit 10 obtains the transmitted learning data (step S302). FIG. 4 shows an example of the learning data used in the exemplary embodiment of the present invention. In step S302, the data obtaining unit 10 also transfers the obtained learning data to the attribute name encryption unit 21 of the encryption unit 20.

Next, the attribute name encryption unit 21 encrypts attribute names included in the input learning data (see FIG. 4) in accordance with a certain rule (step S303). Examples of an encryption method used here include encryption using the Caesar cipher and encryption using the Advanced Encryption Standard (AES). One of these encryption methods is arbitrarily selected.

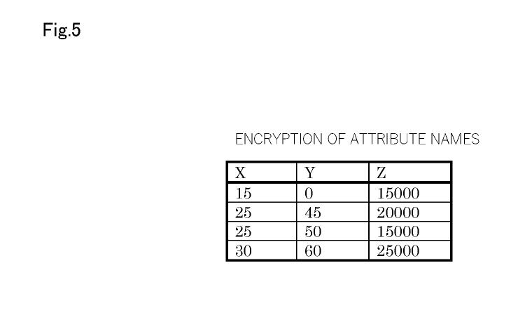

Step S303 places the learning data in the state shown in FIG. 5. FIG. 5 shows an example of the learning data in which the attribute names have been encrypted in the exemplary embodiment of the present invention. In step S303, the attribute name encryption unit 21 also transfers the learning data with the encrypted attribute names (see FIG. 5) to the standardization attribute encryption unit 22.

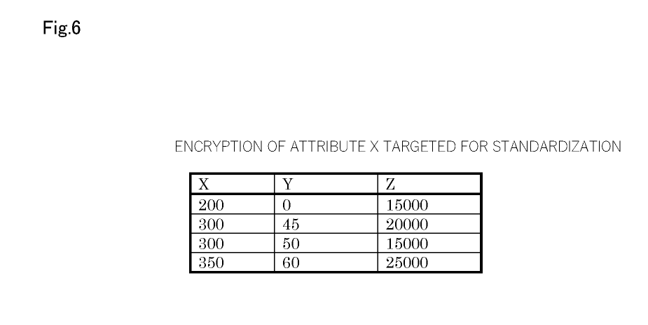

Next, based on the analysis process definition, the standardization attribute encryption unit 22 specifies an attribute targeted for standardization, and encrypts data values that belong to the specified attribute (attribute X in an example of FIG. 6) through standardization processing that uses a specific calculation formula (step S304).

Specifically, as shown in FIG. 6, the standardization attribute encryption unit 22 according to the present exemplary embodiment multiplies all samples of attribute X by a certain value (e.g., 10), and adds another certain value (e.g., 50) to values of the obtained products. FIG. 6 shows an example of the learning data in which the specific attribute has been standardized in the exemplary embodiment of the present invention.

In step S304, the standardization attribute encryption unit 22 also transfers the learning data in which the attribute targeted for standardization has been encrypted (see FIG. 6) to the binarization attribute encryption unit 23. Samples of attribute X after standardization of step S304 and samples of attribute X before standardization have a certain corresponding relationship with each other.

Next, based on the analysis process definition, the binarization attribute encryption unit 23 specifies an attribute targeted for binarization, specifies how many threshold values are present, and encrypts data values that belong to the specified attribute through binarization processing that uses the specified threshold(s) (step S305).

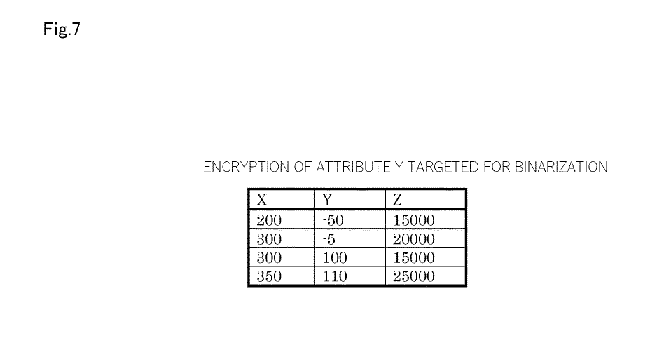

Specifically, as shown in FIG. 7, among all samples of attribute Y targeted for binarization, the binarization attribute encryption unit 23 adds an arbitrary value (e.g., 50) to values of samples equal to or larger than a threshold (e.g., 50), and subtracts an arbitrary value (e.g., 50) from values of samples smaller than the threshold. FIG. 7 shows an example of the learning data in which the specific attribute has been binarized in the exemplary embodiment of the present invention.

In step S305, the binarization attribute encryption unit 23 also transfers the learning data in which the attribute targeted for binarization has been encrypted (see FIG. 7) to the data output unit 30. Samples of attribute Y after binarization of step S305 and samples of attribute Y before binarization have a certain corresponding relationship with each other.

Thereafter, the data output unit 30 transmits the encrypted learning data shown in FIG. 7 to the analysis application 210 of the cloud system 200 via the Internet 400 (step S306).

### Processing for Generating Prediction Model

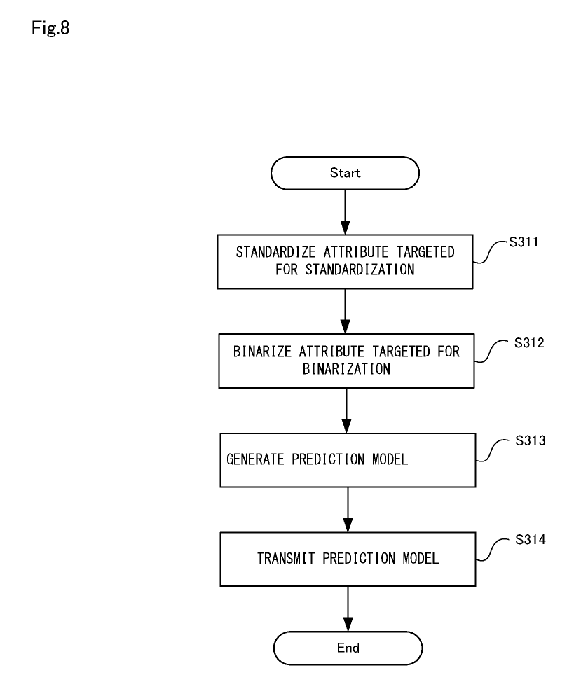

Using FIGS. 8 to 11, the following describes processing executed by the analysis application 210 to generate a prediction model. FIG. 8 is a flowchart of processing executed by the analysis application according to the exemplary embodiment of the present invention to generate a prediction model.

This processing is based on the premise that the analysis process definition input unit 330 transmits the analysis process definition to the cloud system 200 via the Internet 400. The analysis application 210 arranges the standardization component 211, the binarization component 212, and the analysis engine 213 in accordance with the transmitted analysis process definition.

As shown in FIG. 8, first, the transmitted learning data (see FIG. 7) is transferred to the standardization component 211 in the analysis application 210. Then, the standardization component 211 standardizes the attribute targeted for standardization in the learning data (step S311).

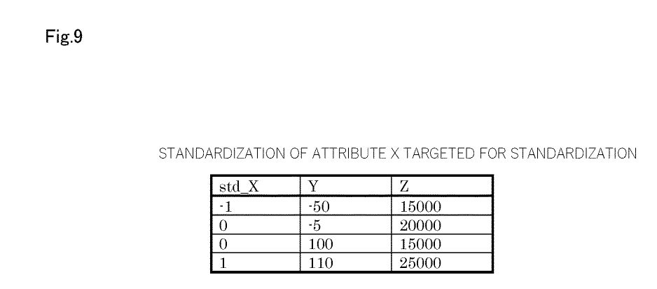

Specifically, the standardization component 211 standardizes data values of attribute X as shown in FIG. 9. FIG. 9 shows an example of the learning data that has been standardized by the analysis application in the exemplary embodiment of the present invention. In the example of FIG. 9, processing for normalizing data values of attribute X in a range of −1 to +1 is executed as standardization processing. The standardization component 211 transfers the learning data in which the attribute targeted for standardization has been standardized (see FIG. 9) to the binarization component 212.

Next, the binarization component 212 binarizes the attribute targeted for binarization in the learning data (step S312).

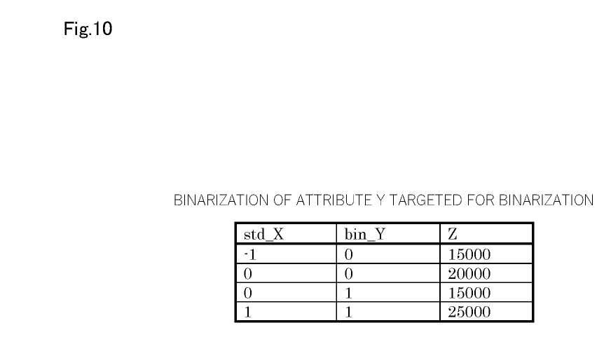

Specifically, as shown in FIG. 10, the binarization component 212 binarizes data values of attribute Y. FIG. 10 shows an example of the learning data that has been binarized by the analysis application in the exemplary embodiment of the present invention. In the example of FIG. 10, processing for changing data values of attribute Y that are smaller than 50 to 0 (bin_Y=0) and changing data values of attribute Y that are equal to or larger than 50 to 1 (bin_Y=1) is executed as binarization processing. The binarization component 212 transfers the learning data in which the attribute targeted for binarization has been binarized (see FIG. 10) to the analysis engine 213.

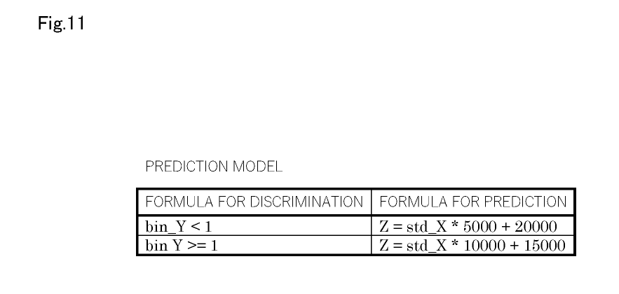

Next, the analysis engine 213 generates a prediction model shown in FIG. 11 using the learning data received from the binarization component 212 (step S313). FIG. 11 shows an example of the prediction model generated in the exemplary embodiment of the present invention.

Thereafter, the analysis engine 213 transmits the generated prediction model, together with the used analysis process definition, to the analysis result storage device 230 via the Internet 400 (step S314). The prediction model and the analysis process definition are accordingly stored to the analysis result storage device 230.

### Processing for Encrypting Prediction Data

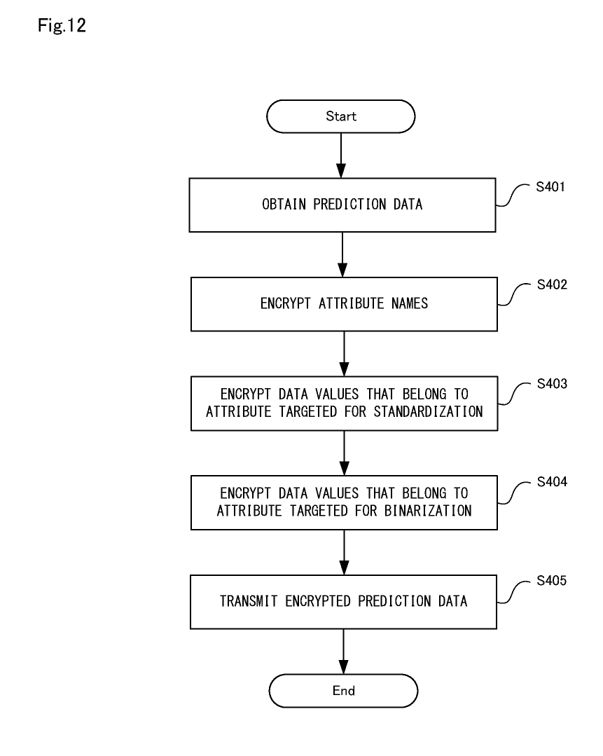

Using FIGS. 12 to 16, the following describes processing for encrypting prediction data. FIG. 12 is a flowchart of processing executed by the data processing device according to the exemplary embodiment of the present invention to encrypt prediction data.

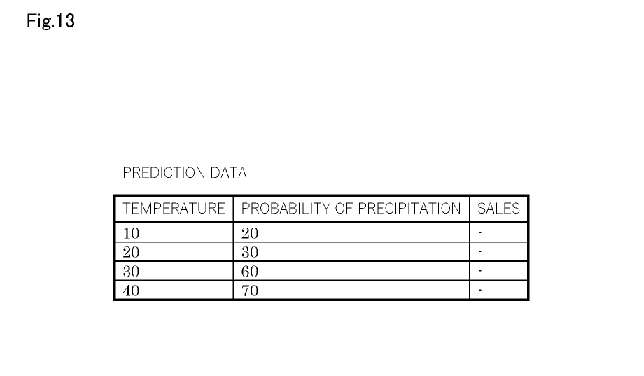

As shown in FIG. 12, first, the prediction data input unit 320 of the terminal device 300 transmits prediction data shown in FIG. 13 to the data processing device 100, and the data obtaining unit 10 obtains the transmitted prediction data (step S401). FIG. 13 shows an example of the prediction data used in the exemplary embodiment of the present invention. In step S401, the data obtaining unit 10 also transfers the obtained prediction data to the attribute name encryption unit 21 of the encryption unit 20.

Next, the attribute name encryption unit 21 encrypts attribute names included in the input prediction data (see FIG. 13) in accordance with a certain rule (step S402). Examples of an encryption method used here include encryption using the Caesar cipher and encryption using the Advanced Encryption Standard (AES).

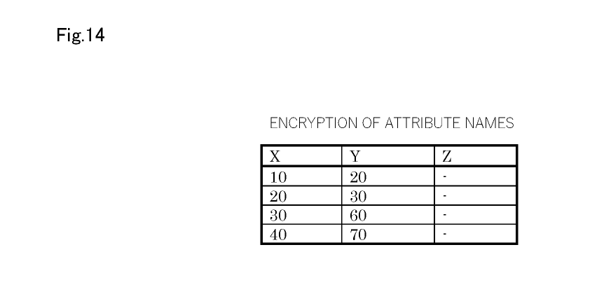

Step S402 places the prediction data in the state shown in FIG. 14. FIG. 14 shows an example of the prediction data in which the attribute names have been encrypted in the exemplary embodiment of the present invention. In step S402, the attribute name encryption unit 21 also transfers the prediction data with the encrypted attribute names (see FIG. 14) to the standardization attribute encryption unit 22.

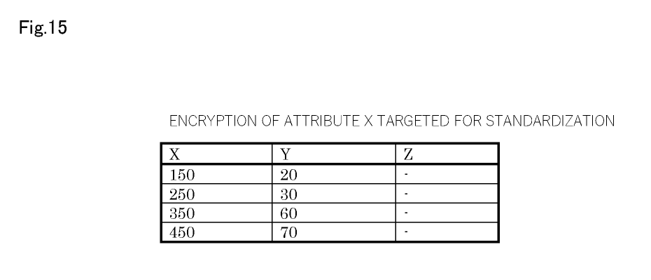

Next, based on the analysis process definition, the standardization attribute encryption unit 22 specifies an attribute targeted for standardization, and encrypts data values that belong to the specified attribute (attribute X in an example of FIG. 15) through standardization processing that uses a specific calculation formula (step S403).

Specifically, as shown in FIG. 15, the standardization attribute encryption unit 22 multiplies all samples of attribute X by a certain value (e.g., 10), and adds another certain value (e.g., 50) to values of the obtained products, similarly to the example of step S304 shown in FIG. 3. FIG. 15 shows an example of the prediction data in which the specific attribute has been standardized in the exemplary embodiment of the present invention.

In step S403, the standardization attribute encryption unit 22 also transfers the prediction data in which the attribute targeted for standardization has been encrypted (see FIG. 15) to the binarization attribute encryption unit 23.

Next, based on the analysis process definition, the binarization attribute encryption unit 23 specifies an attribute targeted for binarization, specifies how many threshold values are present, and encrypts data values that belong to the specified attribute through binarization processing that uses the specified threshold(s) (step S404).

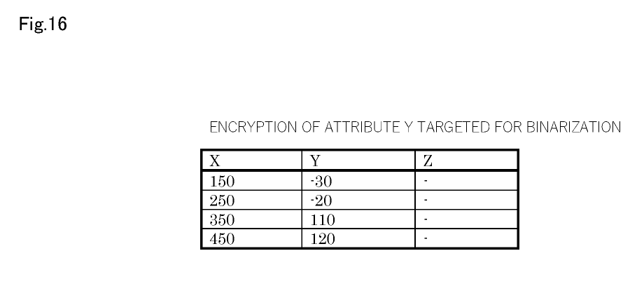

Specifically, as shown in FIG. 16, among all samples of attribute Y targeted for binarization, the binarization attribute encryption unit 23 adds an arbitrary value (e.g., 50) to values of samples equal to or larger than a threshold, and subtracts an arbitrary value (e.g., 50) from values of samples smaller than the threshold, similarly to the example of step S305 shown in FIG. 3. FIG. 16 shows an example of the prediction data in which the specific attribute has been binarized in the exemplary embodiment of the present invention.

In step S404, the binarization attribute encryption unit 23 also transfers the prediction data in which the attribute targeted for binarization has been encrypted (see FIG. 16) to the data output unit 30.

Thereafter, the data output unit 30 transmits the encrypted prediction data shown in FIG. 16 to the prediction application 220 of the cloud system 200 via the Internet 400 (step S405).

### Prediction Processing

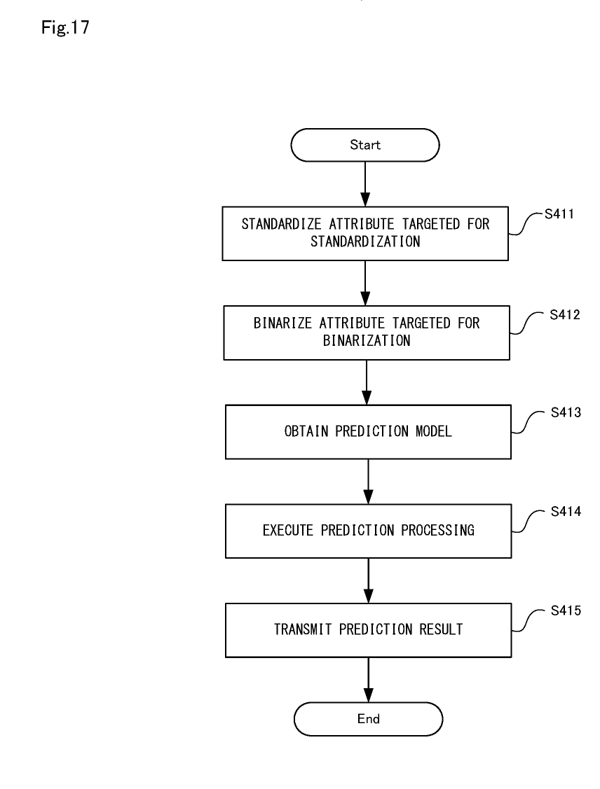

Using FIGS. 17 to 20, the following describes prediction processing executed by the prediction application 220. FIG. 17 is a flowchart of prediction processing executed by the prediction application according to the exemplary embodiment of the present invention.

This processing is based on the premise that the analysis process definition input unit 330 transmits the analysis process definition to the cloud system 200 via the Internet 400. The prediction application 220 arranges the standardization component 221, the binarization component 222, and the analysis engine 223 in accordance with the transmitted analysis process definition.

As shown in FIG. 17, first, the transmitted prediction data (see FIG. 16) is transferred to the standardization component 221 in the prediction application 220. Then, the standardization component 221 standardizes the attribute targeted for standardization in the prediction data (step S411).

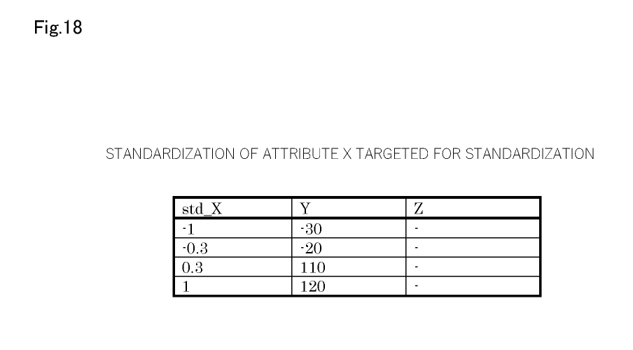

Specifically, the standardization component 221 standardizes data values of attribute X as shown in FIG. 18. FIG. 18 shows an example of the prediction data that has been standardized by the prediction application in the exemplary embodiment of the present invention. In the example of FIG. 18, processing for normalizing data values of attribute X in a range of −1 to +1 is executed as standardization processing. The standardization component 221 transfers the prediction data in which the attribute targeted for standardization has been standardized (see FIG. 18) to the binarization component 222.

Next, the binarization component 222 binarizes the attribute targeted for binarization in the prediction data (step S412).

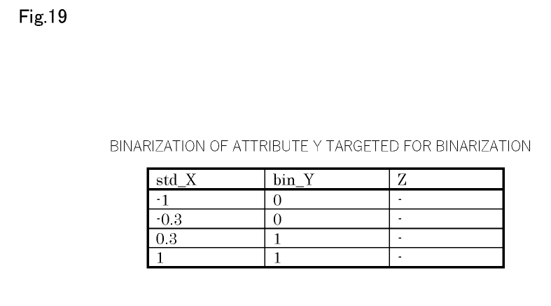

Specifically, as shown in FIG. 19, the binarization component 222 binarizes data values of attribute Y. FIG. 19 shows an example of the prediction data that has been binarized by the prediction application in the exemplary embodiment of the present invention. In the example of FIG. 19, processing for changing data values of attribute Y that are smaller than 50 to 0 (bin_Y=0) and changing data values of attribute Y that are equal to or larger than 50 to 1 (bin_Y=1) is executed as binarization processing, similarly to the example of FIG. 10. The binarization component 222 transfers the prediction data in which the attribute targeted for binarization has been binarized (see FIG. 19) to the analysis engine 223.

Next, the analysis engine 223 obtains the prediction model shown in FIG. 11 from the analysis result storage device 230 via the Internet 400 (step S413).

Next, the analysis engine 223 executes prediction processing by applying the prediction data received from the binarization component 222 to the prediction model (step S414).

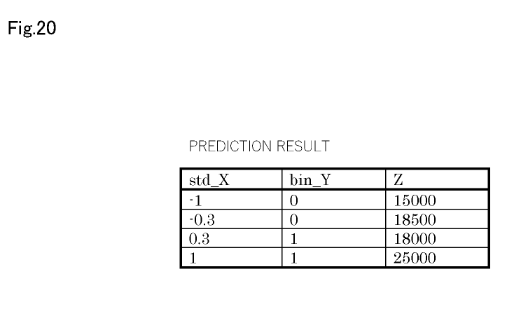

Thereafter, the analysis engine 223 transmits the prediction result shown in FIG. 20 to the prediction result storage device 240 via the Internet 400 (step S415). FIG. 20 shows an example of the prediction result obtained by the prediction application in the exemplary embodiment of the present invention. The prediction result is accordingly stored to the prediction result storage device 240. The user can check the prediction result by accessing the prediction result storage device 240 via the terminal device 300.

### Processing for Visualizing Prediction Model

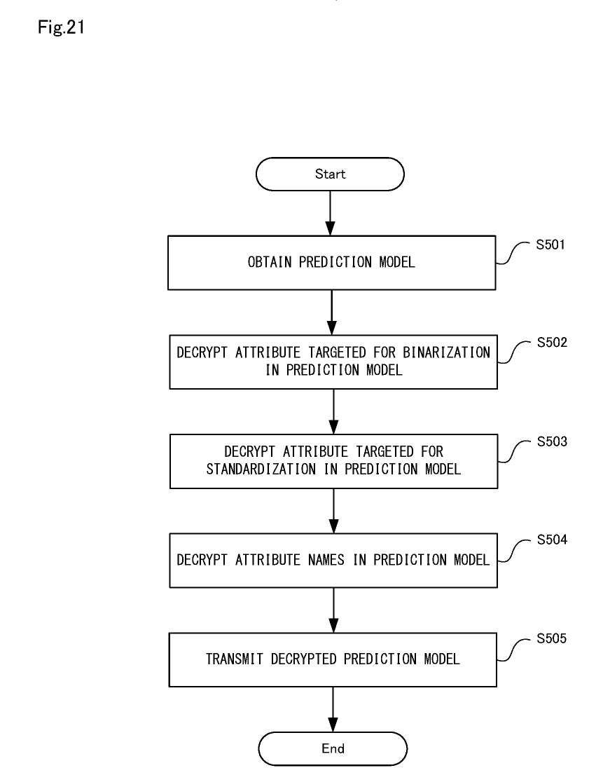

Using FIGS. 21 to 24, the following describes processing for visualizing the prediction model. FIG. 21 is a flowchart of processing executed by the data processing device according to the exemplary embodiment of the present invention to visualize the prediction model.

As shown in FIG. 21, first, the decryption unit 40 of the data processing device 100 obtains the prediction model (see FIG. 11) from the analysis result storage device 230 via the Internet 400 (step S501). In the decryption unit 40, the obtained prediction model is transferred to the binarization attribute decryption unit 43.

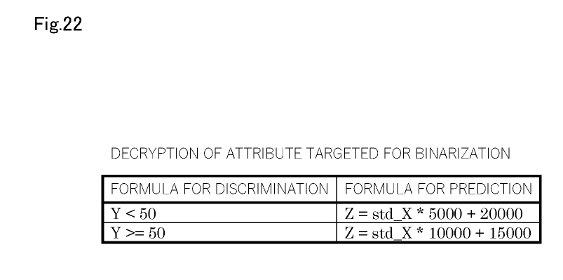

Next, the binarization attribute decryption unit 43 specifies, from the prediction model, a portion related to values that have undergone binarization processing, and decrypts the specified portion (step S502). Specifically, as shown in FIG. 22, the binarization attribute decryption unit 43 decrypts values related to the attribute targeted for binarization, bin_Y, based on the analysis process definition. FIG. 22 shows an example of the prediction model in which the attribute targeted for binarization has been decrypted in the exemplary embodiment of the present invention.

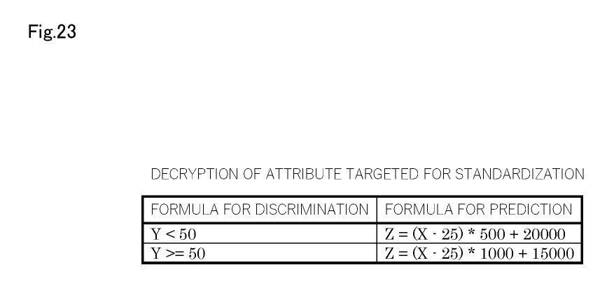

Next, the standardization attribute decryption unit 42 specifies, from the prediction model, a portion related to values that have undergone standardization processing, and decrypts the specified portion (step S503). Specifically, as shown in FIG. 23, the standardization attribute decryption unit 42 decrypts values related to the attribute targeted for standardization, std_X, based on the analysis process definition. FIG. 23 shows an example of the prediction model in which the attribute targeted for standardization has been decrypted in the exemplary embodiment of the present invention.

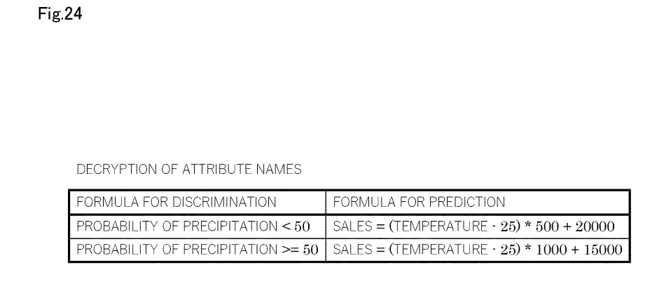

Next, the attribute name decryption unit 41 specifies, from the prediction model, a portion related to encrypted attribute names, and decrypts the specified portion (step S504). Specifically, as shown in FIG. 24, the attribute name decryption unit 41 decrypts the attribute names based on the analysis process definition. FIG. 24 shows an example of the prediction model in which the attribute names have been decrypted in the exemplary embodiment of the present invention.

Next, the data output unit 30 transmits the decrypted prediction model (see FIG. 24) to the terminal device 300 (step S505). The prediction model visualization unit 340 of the terminal device 300 accordingly generates image data for visualizing the transmitted prediction model, and inputs the same to the display device of the terminal device 300. As the display device displays the prediction model on its screen, the user can check the decrypted prediction model.

### Advantageous Effects of Exemplary Embodiment

As described above, the cloud system 200 according to the present exemplary embodiment can generate a prediction model by performing machine learning without executing decryption processing, even when data used in machine learning is encrypted. Furthermore, the cloud system can apply prediction processing to encrypted prediction data. That is to say, in the present exemplary embodiment, learning data and prediction data can be encrypted without impairing the interpretation of a prediction model.

Therefore, the present invention can guarantee security without relying on the provider of the cloud service. Furthermore, as decryption processing need not be executed in prediction processing, machine resources required for processing can be reduced in the cloud system.

### Exemplary Modification

In the foregoing exemplary embodiment, preprocessing (encryption processing) for input data composed of a matrix of numeric values is executed based on standardization and binarization of specific attributes defined by the analysis process definition. However, the present exemplary embodiment is not limited in this way. In the present exemplary embodiment, it is sufficient for the preprocessing to yield the same post-preprocessing result both when encryption has not been performed and when encryption has been performed. The preprocessing may be, for example, processing for removing outliers. In this case, the outliers are removed by replacing values before the preprocessing with values after the preprocessing.

In the case of text data analysis processing in which text data is used as input data and the frequency of appearance of each character or word is analyzed as a feature amount, encryption using a substitution cipher can be applied as the preprocessing to the input text data. In this case, encryption can be performed without affecting the frequencies of appearance, and similar results can be obtained before and after encryption.

On the other hand, in the case of image analysis processing in which image data is used as input data and brightness, saturation, frequency, and the like are analyzed as feature amounts, it is possible to apply encryption that does not affect parts of the feature amounts to be analyzed and that changes only other parts of the feature amounts. Specifically, in this case, encryption is performed by substituting parts of pixels. In this case also, similar results can be obtained before and after encryption.

### Program

It is sufficient for the program according to the present exemplary embodiment to cause a computer to execute steps S301 to S306 shown in FIG. 3, steps S401 to S405 shown in FIG. 12, and steps S501 to S505 shown in FIG. 21. The data processing device 100 and the data processing method according to the present exemplary embodiment can be realized by installing this program in the computer and executing the installed program. In this case, a central processing unit (CPU) of the computer functions as the data obtaining unit 10, the encryption unit 20, the data output unit 30, and the decryption unit 40, and executes processing.

The program according to the present exemplary embodiment may be executed by a computer system constructed using a plurality of computers. In this case, for example, each computer may function as a different one of the data obtaining unit 10, the encryption unit 20, the data output unit 30, and the decryption unit 40.

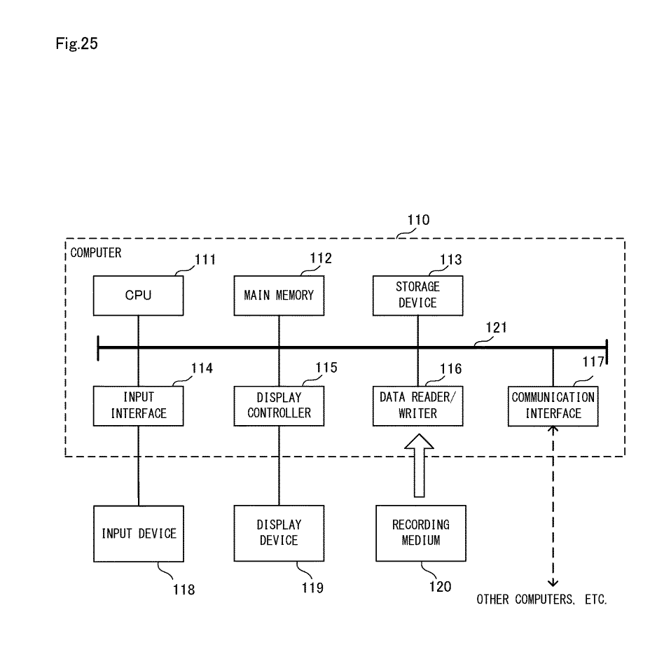

Using FIG. 25, the following describes a computer that realizes the data processing device 100 by executing the program according to the present exemplary embodiment. FIG. 25 is a block diagram showing an example of the computer that realizes the data processing device according to the exemplary embodiment of the present invention.

As shown in FIG. 25, a computer 110 includes a CPU 111, a main memory 112, a storage device 113, an input interface 114, a display controller 115, a data reader/writer 116, and a communication interface 117. These components are connected in such a manner that they can perform data communication with one another via a bus 121.

The CPU 111 performs various types of calculation by deploying the program (code) according to the present exemplary embodiment stored in the storage device 113 to the main memory 112, and executing the deployed program in a predetermined order. The main memory 112 is typically a volatile storage device, such as a dynamic random-access memory (DRAM). The program according to the present exemplary embodiment is provided while being stored in a computer-readable recording medium 120. The program according to the present exemplary embodiment may be distributed over the Internet connected via the communication interface 117.

Specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120. The data reader/writer 116 reads out the program from the recording medium 120, and writes the result of processing of the computer 110 to the recording medium 120. The communication interface 117 mediates data transmission between the CPU 111 and other computers.

Specific examples of the recording medium 120 include: a general-purpose semiconductor storage device, such as CompactFlash® (CF) and Secure Digital (SD); a magnetic recording medium, such as a flexible disk; and an optical recording medium, such as a compact disc read-only memory (CD-ROM).

The data processing device 100 according to the present exemplary embodiment can also be realized using items of hardware corresponding to various components, rather than using the computer having the program installed therein. Furthermore, a part of the data processing device 100 may be realized by the program, and the remaining part of the data processing device 100 may be realized by hardware.

A part or an entirety of the foregoing exemplary embodiment can be described as, but is not limited to, the following Supplementary Notes 1 to 12.

### Supplementary Note 1

A data processing device for providing learning data to a system that generates a prediction model by performing machine learning, the data processing device including:

a data obtaining unit that obtains the learning data input from the outside;

an encryption unit that encrypts the learning data so that a prediction model generated from the learning data in an unencrypted state and a prediction model generated from the learning data in an encrypted state have a corresponding relationship with each other in terms of parameters, numeric values, and operators; and

a data output unit that outputs the encrypted learning data to the system.

### Supplementary Note 2

The data processing device according to Supplementary Note 1, wherein the encryption unit includes
an attribute name encryption unit that encrypts attribute names in the learning data,
a standardization attribute encryption unit that encrypts data values of the learning data that belong to a specific attribute through standardization processing that uses a specific calculation formula, and
a binarization attribute encryption unit that encrypts data values of the learning data that belong to an attribute other than the specific attribute through binarization processing that uses a threshold.

### Supplementary Note 3

The data processing device according to Supplementary Note 1 or 2, wherein

when the data obtaining unit has obtained prediction data to be used in prediction based on the prediction model,
the encryption unit encrypts the prediction data similarly to the learning data, and
the data output unit outputs the encrypted prediction data to the system.

### Supplementary Note 4

The data processing device according to Supplementary Note 2, further including:

an attribute name decryption unit that specifies, from the prediction model generated from the encrypted learning data, a portion related to the encrypted attribute names, and decrypts the specified portion;

a standardization attribute decryption unit that specifies, from the prediction model, a portion related to values that have undergone the standardization processing, and decrypts the specified portion; and

a binarization attribute decryption unit that specifies, from the prediction model, a portion related to values that have undergone the binarization processing, and decrypts the specified portion.

### Supplementary Note 5

A data processing method for providing learning data to a system that generates a prediction model by performing machine learning, the data processing method including:

(a) a step of obtaining the learning data input from the outside;

(b) a step of encrypting the learning data so that a prediction model generated from the learning data in an unencrypted state and a prediction model generated from the learning data in an encrypted state have a corresponding relationship with each other in terms of parameters, numeric values, and operators; and

(c) a step of outputting the encrypted learning data to the system.

### Supplementary Note 6

The data processing method according to Supplementary Note 5, wherein step (a) includes
   a step of encrypting attribute names in the learning data,
   a step of encrypting data values of the learning data that belong to a specific attribute through standardization processing that uses a specific calculation formula, and
   a step of encrypting data values of the learning data that belong to an attribute other than the specific attribute through binarization processing that uses a threshold.

### Supplementary Note 7

The data processing method according to Supplementary Note 5 or 6, wherein

when prediction data to be used in prediction based on the prediction model has been obtained in step (a),
the prediction data is encrypted similarly to the learning data in step (b), and
the encrypted prediction data is output to the system in step (c).

### Supplementary Note 8

The data processing method according to Supplementary Note 6, further including:

(d) a step of specifying, from the prediction model generated from the encrypted learning data, a portion related to the encrypted attribute names, and decrypting the specified portion;

(e) a step of specifying, from the prediction model, a portion related to values that have undergone the standardization processing, and decrypting the specified portion; and

(f) a step of specifying, from the prediction model, a portion related to values that have undergone the binarization processing, and decrypting the specified portion.

### Supplementary Note 9

A computer-readable recording medium having recorded therein a program for, using a computer, providing learning data to a system that generates a prediction model by performing machine learning, the program including an instruction that causes the computer to execute:

(a) a step of obtaining the learning data input from the outside;

(b) a step of encrypting the learning data so that a prediction model generated from the learning data in an unencrypted state and a prediction model generated from the learning data in an encrypted state have a corresponding relationship with each other in terms of parameters, numeric values, and operators; and

(c) a step of outputting the encrypted learning data to the system.

### Supplementary Note 10

The computer-readable recording medium according to Supplementary Note 9, wherein step (a) includes
   a step of encrypting attribute names in the learning data,
   a step of encrypting data values of the learning data that belong to a specific attribute through standardization processing that uses a specific calculation formula, and
   a step of encrypting data values of the learning data that belong to an attribute other than the specific attribute through binarization processing that uses a threshold.

### Supplementary Note 11

The computer-readable recording medium according to Supplementary Note 9 or 10, wherein

when prediction data to be used in prediction based on the prediction model has been obtained in step (a),
the prediction data is encrypted similarly to the learning data in step (b), and
the encrypted prediction data is output to the system in step (c).

### Supplementary Note 12

The computer-readable recording medium according to Supplementary Note 10, wherein

the instruction causes the computer to further execute:
(d) a step of specifying, from the prediction model generated from the encrypted learning data, a portion related to the encrypted attribute names, and decrypting the specified portion;
(e) a step of specifying, from the prediction model, a portion related to values that have undergone the standardization processing, and decrypting the specified portion; and
(f) a step of specifying, from the prediction model, a portion related to values that have undergone the binarization processing, and decrypting the specified portion.

As described above, the present invention enables a system to perform machine learning without executing decryption processing, even when data used in machine learning is encrypted. The present invention is useful in a system that handles a variety of goods and requires massive model constructions, such as a solution that predicts demand for daily food products and a solution that predicts selling prices of automobiles.

While the invention has been particularly shown and described with reference to the exemplary embodiment thereof, the invention is not limited to this exemplary embodiment. It will be understood by those of ordinary skill in the art that various changes in form and details may be made therein without departing from the spirit and scope of the present invention as defined by the claims.

What is claimed is:

1. A data processing device for providing learning data to a system that generates a prediction model by performing machine learning, the data processing device comprising:
a data obtaining unit that obtains the learning data input from the outside;
an encryption unit that encrypts the learning data so that a prediction model generated from the learning data in an unencrypted state and a prediction model generated from the learning data in an encrypted state have a corresponding relationship with each other in terms of parameters, numeric values, and operators; and
a data output unit that outputs the encrypted learning data to the system.

2. The data processing device according to claim 1, wherein
the encryption unit comprises
an attribute name encryption unit that encrypts attribute names in the learning data,
a standardization attribute encryption unit that encrypts data values of the learning data that belong to a specific attribute through standardization processing that uses a specific calculation formula, and
a binarization attribute encryption unit that encrypts data values of the learning data that belong to an attribute other than the specific attribute through binarization processing that uses a threshold.

3. The data processing device according to claim 1, wherein
when the data obtaining unit has obtained prediction data to be used in prediction based on the prediction model,
the encryption unit encrypts the prediction data similarly to the learning data, and
the data output unit outputs the encrypted prediction data to the system.

4. The data processing device according to claim 2, further comprising:
an attribute name decryption unit that specifies, from the prediction model generated from the encrypted learning data, a portion related to the encrypted attribute names, and decrypts the specified portion;
a standardization attribute decryption unit that specifies, from the prediction model, a portion related to values that have undergone the standardization processing, and decrypts the specified portion; and
a binarization attribute decryption unit that specifies, from the prediction model, a portion related to values that have undergone the binarization processing, and decrypts the specified portion.

5. A data processing method for providing learning data to a system that generates a prediction model by performing machine learning, the data processing method comprising:
(a) a step of obtaining the learning data input from the outside;
(b) a step of encrypting the learning data so that a prediction model generated from the learning data in an unencrypted state and a prediction model generated from the learning data in an encrypted state have a corresponding relationship with each other in terms of parameters, numeric values, and operators; and
(c) a step of outputting the encrypted learning data to the system.

6. A non-transitory computer-readable recording medium having recorded therein a program for, using a computer, providing learning data to a system that generates a prediction model by performing machine learning, the program including an instruction that causes the computer to execute:
(a) a step of obtaining the learning data input from the outside;
(b) a step of encrypting the learning data so that a prediction model generated from the learning data in an unencrypted state and a prediction model generated from the learning data in an encrypted state have a corresponding relationship with each other in terms of parameters, numeric values, and operators; and
(c) a step of outputting the encrypted learning data to the system.
